(19) United States
(12) Patent Application Publication
(10) Pub. No.: US 2026/0061982 A1
(43) Pub. Date: Mar. 5, 2026

(54) Adapter Module and Module System

(71) Applicant: KB Intellectual Property GmbH & Co., KG, Pullach (DE)

(72) Inventor: Ralf WOERNER, Tiefenbronn (DE)

(21) Appl. No.: 19/316,468

(22) Filed: Sep. 2, 2025

(30) Foreign Application Priority Data
Sep. 3, 2024 (DE) 10 2024 125 051.8

(51) Int. Cl. B60T 13/68; B60T 13/66

(52) U.S. Cl. CPC B60T 13/683; B60T 13/662

(57) ABSTRACT

An adapter module is configured to be connected in place of a muffler module at at least one pressure-modulator venting interface of a pressure-modulator housing of a pressure modulator, which modulates an input pressure and is controlled by an electric and/or pneumatic signal, of a pneumatic or electropneumatic brake device of a vehicle. The pressure modulator modulates an output pressure, in particular a brake pressure, on the basis of the input pressure and depending on the electric and/or pneumatic signal, and in the process releases compressed air via the at least one pressure-modulator venting interface. The adapter module includes an adapter having a through-opening, a first adapter interface and a second adapter interface, and a line, wherein the through-opening leads into the first adapter interface, which is configured to be releasably connected to the at least one pressure-modulator venting interface, and wherein the through-opening leads into the second adapter interface, which is configured to be releasably connected to the line or to be connected to the line.

### CROSS REFERENCE TO RELATED APPLICATION

This application claims priority under 35 U.S.C. § 119 from German Patent Application No. 10 2024 125 051.8, filed Sep. 3, 2024, the entire disclosure of which is herein expressly incorporated by reference.

### BACKGROUND AND SUMMARY

The invention relates to an adapter module configured and designed to be connected in place of a muffler module at at least one pressure-modulator venting interface of a pressure-modulator housing of a pressure modulator, which modulates an input pressure and is controlled by an electric and/or pneumatic signal, of a pneumatic or electropneumatic brake device of a vehicle. The invention also relates to a module system of a pneumatic or electropneumatic brake device of a vehicle, and to a pneumatic or electropneumatic brake device of a vehicle comprising at least one module system.

Pneumatic or electropneumatic pressure modulators that are controlled by electric and/or pneumatic signals, such as pressure control modules, parking brake modules, relay valves or trailer control modules of pneumatic or electropneumatic brake devices of commercial vehicles, are generally arranged on the frame of commercial vehicles in the vicinity of the axle and thus at a relatively low level. The modulators aerate or vent the pneumatic service brake cylinders or spring-loaded brake cylinders of the vehicle. In such pressure modulators, in a venting mode, the working air is released into the environment by means of a muffler. In the case of commercial vehicles that are capable of fording, the problem then arises that, via the mufflers, water can penetrate into the pressure modulators arranged at a low level, and this can impair the operation thereof.

The present invention addresses the problem of specifying measures with which the operational reliability of pressure modulators can be increased. Furthermore, a pneumatic or electropneumatic brake device of a vehicle having functionally reliable pressure modulators is intended to be provided.

This problem is solved according to the invention by the features of the independent claims.

In a first aspect, the invention provides an adapter module configured and designed to be connected in place of a muffler module at at least one pressure-modulator venting interface of a pressure-modulator housing of a pressure modulator, which modulates an input pressure and is controlled by an electric and/or pneumatic signal, of a pneumatic or electropneumatic brake device of a vehicle. The pressure modulator modulates an output pressure, in particular a brake pressure, on the basis of the input pressure and depending on the electric and/or pneumatic signal, and in the process releases compressed air via the at least one pressure-modulator venting interface. The adapter module includes at least:
a) an adapter having a through-opening, a first adapter interface and a second adapter interface,
b) a line, wherein
c) the through-opening leads into the first adapter interface, which is configured and designed to be releasably connected to the at least one pressure-modulator venting interface, and wherein
d) the through-opening leads into the second adapter interface, which is configured and designed to be releasably connected to the line or to be connected to the line.

The expression “to be connected” should be understood as meaning that each connection is at least vapor-tight and liquid-tight and preferably additionally (substantially) pressure-tight. The connection of the line to the second adapter interface can be realized by a releasable connection or a permanent connection. For example, the line and the second adapter interface may form separate components of the adapter module, which are then connected releasably together. Alternatively, the line can also be embodied at least partially integrally or in one piece with the second adapter interface of the adapter, for example in that both are manufactured as an injection molding.

The pressure modulator is in particular a pneumatic or electropneumatic pressure modulator, which modulates a working pressure from an input pressure, for example from a supply pressure originating from a compressed-air tank, in order to aerate or vent a compressed-air consumer, in particular a service brake cylinder or a spring-loaded brake cylinder of the pneumatic or electropneumatic brake device with the working pressure.

The fact that, in place of the standard muffler module, the adapter module can also be connected to the pressure-modulator venting interface of the pressure-modulator housing, makes it possible to guide a line away from the second adapter interface, which opens into the atmosphere in particular at a higher level, with respect to the installation situation or the use position, than the second adapter interface. The line can be, in particular, a pipe, a line or a flexible hose, wherein the line then creates a compressed-air fluidic connection between the pressure-modulator venting interface and the atmosphere. The line can then be arranged on the vehicle, in particular on the commercial vehicle, such that an opening of the free end of the line is at the higher level with respect to the pressure-modulator venting interface.

As a result of the adapter module being connected, in combination with the line, at the pressure-modulator venting interface instead of the muffler module, it is then advantageously possible to prevent water or moisture from penetrating into the pressure-modulator venting interface as a result of the vehicle being driven through shallow watercourses or lakes. Since, furthermore, a certain length of the line is necessary in order to reach the higher level, sound insulation of the discharged compressed air is also ensured, and so the omission of a muffler module at the pressure-modulator venting interface in question does not entail any drawbacks in this regard.

Since the muffler generally has a cylindrical cross section, the adapter, as a replacement element for the muffler, preferably also has a cylindrical cross section. It is also possible for the through-opening in the adapter to be formed centrally and/or cylindrically in the cross section.

According to a particularly preferred embodiment, in the adapter module, the line may be in the form of a (flexible) hose or a pipe.

It is also possible for the adapter module to comprise at least one sealing element which seals off the first adapter interface of the adapter from the at least one pressure-modulator venting interface when the adapter is connected to or at the pressure-modulator venting interface. The at least one sealing element may, in particular, be intended to be arranged between a radially outer circumferential surface of the adapter and a radially inner circumferential surface of the pressure-modulator venting interface.

It is also possible for the adapter module to comprise at least one securing element, which is configured and designed to secure the first adapter interface of the adapter to or to retain it at the pressure-modulator venting interface. The securing element may be, for example, annular.

Furthermore, in the adapter module it may be provided that, at the first adapter interface of the adapter and/or on the securing element, a first part of a form-fitting and releasable connection is formed such that this first part can be connected in a form-fitting and releasable manner to a complementary second part of the form-fitting and releasable connection of the pressure-modulator venting interface. In particular, the first part is in the form of part of a screw connection (internal or external thread) or of part of a bayonet coupling.

In a second aspect, the invention provides a module system of a pneumatic or electropneumatic brake device of a vehicle, which comprises at least the following:
a) at least one pressure modulator, which modulates an input pressure and is controlled by an electric and/or pneumatic signal, wherein the pressure modulator has a pressure-modulator housing with at least one pressure-modulator venting interface and modulates an output pressure, in particular a brake pressure, on the basis of the input pressure, in particular on the basis of a supply pressure of a compressed-air tank and depending on the electric and/or pneumatic signal, and in the process releases or vents compressed air via the at least one pressure-modulator venting interface,
b) at least one above-described adapter module, and
c) at least one muffler module having a muffler interface, wherein
d) the first adapter interface of the adapter module and the muffler interface of the muffler module are formed in a complementary manner such that, at the pressure-modulator venting interface, either the adapter module can be connected to the first adapter interface or the muffler module can be connected to the muffler interface (at least in a liquid-tight manner, preferably in a pressure-tight manner).

In such a module system, the muffler module can be exchanged for the adapter module or vice versa, with the advantages already described above.

In the module system, the pressure modulator may be formed by a pressure control module, a trailer control module, a parking brake module or by a relay valve, or comprise one of these components.

Furthermore, in the module system,
a) at the first adapter interface of the adapter or on the securing element, a first part of a form-fitting and releasable connection may be formed, and,
b) at the at least one pressure-modulator venting interface, a second part, formed in a complementary manner to the first part, of the form-fitting and releasable connection may be formed, such that
c) the first part can be connected in a form-fitting and releasable manner to the second part.

It is also possible, in the module system, for the first part and the second part to each be in the form of part of a bayonet coupling.

In a third aspect, the invention provides a pneumatic or electropneumatic brake device of a vehicle, which comprises at least one above-described module system.

In a fourth aspect, the invention provides a method for using the above-described module system on a vehicle, in particular on a commercial vehicle, wherein, with the at least one pressure-modulator venting interface, either:
a) the first adapter interface of the adapter module is connected and one end of the line is connected to the second adapter interface, and the line is arranged on the vehicle such that the other end of the line is at a higher level on the vehicle in the use position than the at least one pressure-modulator venting interface or the second adapter interface, or
b) the muffler interface of the muffler module is connected.

In a fifth aspect, the invention provides a method for using the above-described adapter module on a pressure modulator, wherein the first adapter interface of the adapter module is releasably connected to the at least one pressure-modulator venting interface, in particular instead of an alternative connection to the muffler module.

According to one development of the method, one end of the line may be connected or be already connected at the second adapter interface of the adapter module and the line may be arranged on the vehicle in the use position such that the other end of the line is at a higher level on the vehicle than the at least one pressure-modulator venting interface or the second adapter interface.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a partial cross sectional view of a 2-channel pressure control module of an electropneumatic brake device of a vehicle having an adapter module according to a preferred embodiment of the invention, which is connected at a first pressure-modulator venting interface of a first channel, wherein a muffler is connected at the second pressure-modulator venting interface of the second channel;

FIG. 2 is a perspective bottom view of the 2-channel pressure control module in FIG. 1; and

FIG. 3 is a detail view of FIG. 2.

### DETAILED DESCRIPTION OF THE DRAWINGS

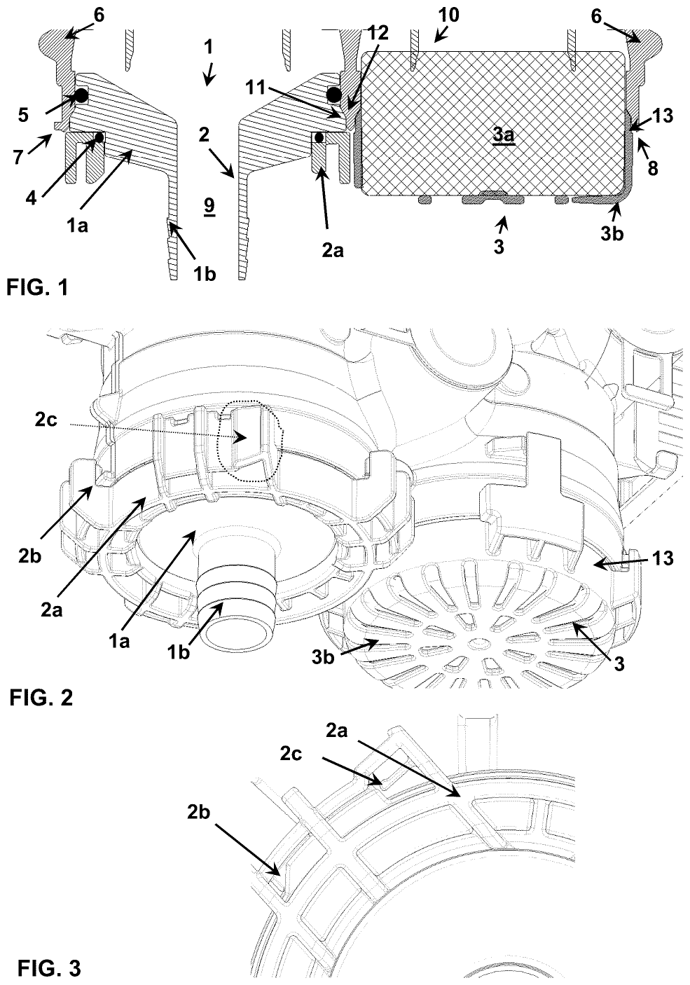

FIGS. 1 to 3 show a 2-channel pressure control module 10 as an example of a pressure modulator of an electropneumatic brake device of a vehicle having an adapter module 1 according to a preferred embodiment of the invention.

The 2-channel pressure control module 10 controls, in two separate channels, in each channel, a brake pressure which is modulated in each case from a supply pressure of a connected compressed-air tank (not shown here). The modulation takes place for each channel depending on an input brake signal from a central EBS control unit which specifies a target brake pressure for each channel, which is then adjusted, with the aid of a valve device that is present and integrated in each channel and is controlled by an integrated control unit in accordance with this specification, in that, for each channel, a pressure sensor measures the output actual brake pressure and informs the integrated control unit, which corrects a target/actual deviation by actuating the valve device in question. The valve device comprises, for each channel, for example an inlet/outlet solenoid valve combination and a relay valve pneumatically controlled thereby, which is connected to a module supply port on one side and to a working port on the other side, which in this case is connected, for example, to a service brake cylinder. For example, the 2-channel pressure control module 10 serves here for the separate control of the brake pressures in the service brake cylinders on a rear axle of the vehicle.

Supply ports of the inlet valve and of the relay valve are, for each channel, connected to a module supply port (not shown here). Venting ports of the outlet valve and of the relay valve for each channel are connected respectively at a pressure-modulator venting interface 7, 8, in order to be able to discharge working air there in venting phases. To be more precise, on a pressure-modulator housing 6 of the 2-channel pressure control module 10, there is a first pressure-modulator venting interface 7 for a first channel and a second pressure-modulator venting interface 8 for a second channel.

While, in this case, the adapter module 1 is connected or arranged for example at the first pressure-modulator venting interface 7 of the first channel, a muffler module 3 is connected to the second pressure-modulator venting interface 8 of the second channel. Both the muffler module 3 and the adapter module 1 are releasably connected to the respective pressure-modulator venting interface 7, 8. The two pressure-modulator venting interfaces 7, 8 are, in this case, for example integral parts of the pressure-modulator housing 6, but may also be embodied as separate components which are then connected to the pressure-modulator housing 6.

The two pressure-modulator venting interfaces 7, 8 are embodied in a standardized or complementary manner such that either an adapter module 1 or a muffler module 3 can be connected at a pressure-modulator venting interface 7 or 8. The example with the 2-channel pressure control module 10 was chosen here in order to demonstrate the exchangeability of the adapter module 1 and of the muffler module 3 at one and the same pressure-modulator venting interface 7 or 8.

The adapter module 1 in this case comprises, for example, a rotationally symmetric and cylindrical adapter 2 having a through-opening 9, a first adapter interface 1a and a second adapter interface 1b, and a line (not shown here), for example in the form of a flexible hose. In this case for example, the central through-opening 9 in the adapter 2 leads into the first adapter interface 1a, which is releasably connected at the first pressure-modulator venting interface 7. The through-opening 9 also leads into the second adapter interface 1b, which in this case is in the form, for example, of a peg-like hose connector and onto which one end of a flexible hose (not shown here) is fitted and retained there in a sealing manner, for example by means of a hose clamp (not shown here).

According to an alternative embodiment that is not shown here, the second adapter interface 1b of the adapter 2 can also be embodied integrally or in one piece with a pipe or a line which then conducts the exhaust air into the atmosphere.

The connection of the adapter module 1 at the first pressure-modulator venting interface 7 can be realized, for example, in that the adapter 2 or the first adapter interface 1a has been pushed to a certain extent axially into a cylindrical opening in a wall of the first pressure-modulator venting interface 7, in this case for example until an axial stop 11 of the adapter 2 or of the first adapter interface 1a butts against a corresponding axial stop 12 on the radially inner circumferential surface of the wall of the first pressure-modulator venting interface 7.

Preferably, a sealing element 5 is arranged in this case between the radially outer circumferential surface of the adapter 2 or of the first adapter interface 1a and a radially inner circumferential surface of the wall of the first pressure-modulator venting interface 7, said sealing element 5 being received, for example, in an encircling radially outer circumferential groove in the adapter 2.

At an edge of the opening in the wall of the first pressure-modulator venting interface 7, the adapter 2 is, for example, axially locked on the pressure-modulator housing 6 by means of a securing ring 2a such that the adapter 2 or the first adapter interface 1a thereof is retained axially and in a radially fixed manner in the opening in the wall of the first pressure-modulator venting interface 7. The securing ring 2a can be retained in particular radially externally on the wall of the first pressure-modulator venting interface 7, for example by means of a releasable first bayonet connection. This first bayonet connection in this case comprises, for example, first bayonet hooks 2b on the securing ring 2a, which cooperate with corresponding bayonet hook receptacles arranged in a distributed manner around the outer circumference of the first pressure-modulator venting interface 7 of the pressure-modulator housing 6.

To secure the first bayonet connection, it is additionally possible for a first latching device 2c to be provided between the securing ring 2a and the first pressure-modulator venting interface 7, this preventing unintentional releasing of the first bayonet connection. The first latching device 2c is arranged preferably in a concealed manner so that unintentional unlocking is prevented. The unlocking of the first latching device 2c is embodied for example such that it can be released only by means of a tool, for example by means of a screwdriver. It is also possible for a tolerance compensating element 4 for axial and/or radial tolerance compensation to be provided between the securing ring 2a and the adapter 2.

Alternatively, any releasable connection between the adapter module 1 and the first pressure-modulator venting interface 7 or the second pressure-modulator venting interface 8 is possible, for example a screw-connection of the securing ring 2a to the radially outer circumferential surface of the wall of the pressure-modulator venting interface 7 or the second pressure-modulator venting interface 8.

The muffler module 3 in this case comprises, for example, a muffler body 3a and a carrier 3b in which the muffler body 3a is retained. In this case, second bayonet hooks (not shown here) can be formed for example on an edge of the carrier 3b, which then forms a muffler interface 13, as in the case of the securing ring 2a, said bayonet hooks then cooperating with corresponding second bayonet hook receptacles arranged in a distributed manner around the outer circumference of the second pressure-modulator venting interface 8 of the pressure-modulator housing 6. It is also possible here, to secure the second bayonet connection, for a second latching device to additionally be provided between the carrier 3b and the second pressure-modulator venting interface 8.

Furthermore, the internal dimensions of the openings in the walls of the two pressure-modulator venting interfaces 7, 8 and the external dimensions of the first adapter interface 1a and of the carrier 3b may be identical in each case. In addition, the first bayonet connection, with which the securing ring 2a is releasably fastened to the first pressure-modulator venting interface 7, is then embodied in a complementary manner to the second bayonet connection, with which the carrier 3b is releasably fastened to the second pressure-modulator venting interface 8. It is then possible for the adapter module 1 and the muffler module 3 to be exchanged for one another at the two pressure-modulator venting interfaces 7, 8.

A first releasable connection between the adapter module 1 and the first pressure-modulator venting interface 7 and a second releasable connection between the muffler module 3 and the second pressure-modulator venting interface 7 are then formed in a complementary manner, as are the muffler module 3 and the adapter module 1 with regard to their respective connection geometries, such that, for example, a muffler module 3 could also be connected at or in the first pressure-modulator venting interface 7 and an adapter module 1 could also be connected at or in the second pressure-modulator venting interface 8.

The flexible hose connected at the second adapter interface 1b then creates a fluidic connection between the first pressure-modulator venting interface 7 and the atmosphere when the free other end of the hose leads into the open. The hose is then arranged on the vehicle in particular such that an opening of the free other end of the hose is preferably at higher level than the first pressure-modulator venting interface 7.

As a result of the connection of the adapter module 1 at the first pressure-modulator venting interface 7 in combination with the hose connected to the adapter 2, in this case, for example, in place of a muffler module 3, it is then advantageously possible to prevent water or moisture penetrating into the first pressure-modulator venting interface 7 as a result of the vehicle being driven through shallow watercourses or lakes. Since the muffler module 3 has been illustrated at or in the second pressure-modulator venting interface 8 in FIGS. 1 and 2 only in order to demonstrate the exchangeability between the adapter module 1 and the muffler module 3, it is contemplated to assume that an adapter module 1 is likewise connected at or in the second pressure-modulator venting interface 8, in order to prevent the penetration of moisture or water there too.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Adapter module
1a First adapter interface
1b Second adapter interface
2 Adapter
2a Securing ring
2b First bayonet hook
2c First latching device
3 Muffler module
3a Muffler body
3b Carrier
4 Tolerance compensating element
5 Sealing element
6 Pressure-modulator housing
7 First pressure-modulator venting interface
8 Second pressure-modulator venting interface
9 Through-opening
10 2-Channel pressure control module (pressure modulator)
11 Axial stop
12 Axial stop
13 Muffler interface

What is claimed is:

1. An adapter module configured to be connected in place of a muffler module at at least one pressure-modulator venting interface of a pressure-modulator housing of a pressure modulator, which modulates an input pressure and is controlled by an electric and/or pneumatic signal, of a pneumatic or electropneumatic brake of a vehicle,
wherein the pressure modulator modulates an output brake pressure based on the input pressure and depending on the electric and/or pneumatic signal, and in the process releases compressed air via the at least one pressure-modulator venting interface,
the adaptor module comprising:
a) an adapter having a through-opening, a first adapter interface, and a second adapter interface;
b) a line,
c) wherein the through-opening leads into the first adapter interface, which is configured to be releasably connected to the at least one pressure-modulator venting interface, and
d) wherein the through-opening leads into the second adapter interface, which is configured to be releasably connected to the line or to be connected to the line.

2. The adapter module as claimed in claim 1, wherein the line is a hose or pipe.

3. The adapter module as claimed in claim 1, further comprising:
at least one sealing element which seals off the first adapter interface of the adapter from the at least one pressure-modulator venting interface.

4. The adapter module as claimed in claim 1, further comprising:
at least one securing element configured to secure the first adapter interface of the adapter to, or to retain it at, the pressure-modulator venting interface.

5. The adapter module as claimed in claim 1, wherein
a) at the first adapter interface of the adapter and/or
b) on the securing element,
a first part of a form-fitting and releasable connection is formed so that the first part is connectable in a form-fitting and releasable manner to a complementary second part of the form-fitting and releasable connection of the at least one pressure-modulator venting interface.

6. The adapter module as claimed in claim 5, wherein the first part is part of a bayonet coupling.

7. A module system of a pneumatic or electropneumatic brake device of a vehicle, comprising:
a) at least one pressure modulator, which modulates an input pressure and is controlled by an electric and/or pneumatic signal, wherein the pressure modulator has a pressure-modulator housing with at least one pressure-modulator venting interface and modulates an output brake pressure on the basis of the input pressure and depending on the electric and/or pneumatic signal, and in the process releases compressed air via the at least one pressure-modulator venting interface;
b) at least one adapter module as claimed in claim 1; and
c) at least one muffler module having a muffler interface,
d) wherein the first adapter interface of the adapter module or of the adapter and the muffler interface of the muffler module are formed in a complementary manner such that, at the at least one pressure-modulator venting interface, either the adapter module is connectable to the first adapter interface or the muffler module is connectable to the muffler interface.

8. The module system as claimed in claim 7, wherein the pressure modulator is a pressure control module, a trailer control module or a relay valve.

9. The adapter module as claimed in claim 7, wherein:
a) at the first adapter interface of the adapter or on the securing element, a first part of a form-fitting and releasable connection is formed, and
b) at the at least one pressure-modulator venting interface, a second part, formed in a complementary manner to the first part, of the form-fitting and releasable connection is formed, such that
c) the first part is connectable in a form-fitting and releasable manner to the second part.

10. The module system as claimed in claim 9, wherein the first part and the second part are each in the form of part of a bayonet coupling.

11. A pneumatic or electropneumatic brake device of a vehicle comprising at least one module system as claimed in claim 7.

12. A method of connecting a module system having an adapter module, having a pressure modulator which modulates an input pressure and is controlled by an electric and/or pneumatic signal, wherein the pressure modulator has a pressure-modulator housing with at least one pressure-modulator venting interface and modulates an output brake pressure on the basis of the input pressure and depending on the electric and/or pneumatic signal, and in the process releases compressed air via the at least one pressure-modulator venting interface, and having a muffler module, on a vehicle,
the method comprising:
with the at least one pressure modulator venting interface, either:
a) a first adapter interface of the adapter module is connected and one end of a line is connected to a second adapter interface, and the line is arranged on the vehicle such that the other end of the line is at a higher level on the vehicle in the use position than the at least one pressure-modulator venting interface or the second adapter interface, or
b) a muffler interface of the muffler module is connected.

13. A method for using the adapter module as claimed in claim 1, on the pressure modulator, wherein
the at least one pressure-modulator venting interface is releasably connected to the first adapter interface of the adapter module instead of an alternative connection to the muffler module.

14. The method as claimed in claim 13, wherein
one end of the line is connected at the second adapter interface of the adapter module and the line is arranged on the vehicle in the use position such that the other end of the line is at a higher level on the vehicle than the at least one pressure-modulator venting interface or the second adapter interface.
